(19) United States
(12) Patent Application Publication
(10) Pub. No.: US 2016/0135935 A1
(43) Pub. Date: May 19, 2016

(54) AIR SYRINGE FOR DENTISTRY

(71) Applicant: Shurcon Manufacturing (Zhejiang) Co., Ltd., Jiaxing (CN)

(72) Inventors: Sherry Chen, Jiaxing (CN); Shunxu Qiu, Jiaxing (CN)

(21) Appl. No.: 14/945,315

(22) Filed: Nov. 18, 2015

(30) Foreign Application Priority Data
Nov. 19, 2014 (CN) 201410660033.9
Nov. 19, 2014 (CN) 201410660464.5

(51) Int. Cl. A61C 17/022; A61C 17/02; A61C 1/08

(52) U.S. Cl. CPC A61C 17/022; A61C 1/088; A61C 17/0202; A61C 17/0217

(57) ABSTRACT

An air syringe for dentistry includes a nozzle portion, a head portion connected to the nozzle portion, a handle connected to the head portion, an air tube and a water tube positioned in the handle, and a heating module positioned in the handle. The head portion defines a tube channel inside which is configured to selectively connect the nozzle portion to the air tube or the water tube. The heating module includes a heating bar, a temperature controller, and a heat storage member. The air tube and the water tube pass through the heat storage member. The heating bar is embedded in the heat storage member. The temperature controller is positioned on the heat storage member and is electrically coupled to the heating bar.

### CROSS-REFERENCE TO RELATED APPLICATIONS

This application claims priority to Chinese Patent Application No. 201410660033.9 and 201410660464.5 filed on Nov. 19, 2014, the contents of which are incorporated by reference herein in its entirety.

### FIELD

The subject matter herein generally relates to an air syringe for dentistry with illuminating and heating functions.

### BACKGROUND

A conventional air syringe for dentistry is used to cure for the patients with tooth problems. It is difficult to check in the mouth of a patient as the light is weak. Sometimes an extra illumination device is needed for lighting in the mouth. It is also a large pain for the patient as the air syringe only provides cold water when used. Therefore, an improved air syringe with illuminating and heating functions is needed.

CONTENTS OF THE INVENTION

As a result, the purpose of the invention is to provide an air syringe for dentistry with illuminating and heating functions.

An air syringe for dentistry includes a nozzle portion, a head portion connected to the nozzle portion, a handle connected to the head portion, an air tube and a water tube positioned in the handle, and a heating module positioned in the handle. The head portion defines a tube channel inside which is configured to selectively connect the nozzle portion to the air tube or the water tube. The heating module includes a heating bar, a temperature controller, and a heat storage member. The air tube and the water tube pass through the heat storage member. The heating bar is embedded in the heat storage member. The temperature controller is positioned on the heat storage member and is electrically coupled to the heating bar.

In at least one embodiment, the air syringe for dentistry further comprises an illumination module positioned in the head portion or the handle; the head portion defines an opening toward the nozzle portion and an illumination channel inside; and the illumination channel is communicated with the opening.

In at least one embodiment, the air syringe for dentistry further comprises a nozzle connecting member and a head connecting member; the nozzle portion is permanently connected to the nozzle connecting member; the head connecting member is permanently connected to the head portion; and the nozzle connecting member is rotatably connected to the head connecting member.

In at least one embodiment, the air syringe for dentistry further comprises a tube fixing member positioned in the handle; and the tube fixing member is configured to fix the air tube and the water tube.

In at least one embodiment, the heat storage member defines a plurality of holes therein; and the heating bar is embedded in the plurality of holes.

In at least one embodiment, the air syringe for dentistry further comprises an air button and a water button positioned on the head portion and are connected to the tube channel; the air button is configured to control the nozzle portion connect to the air tube; and the water button is configured to control the nozzle portion connect to the water tube.

In at least one embodiment, at least parts of the illumination module is positioned in the illumination channel; and the illumination module is configured to emit light which is projected from the opening via the illumination channel.

In at least one embodiment, the illumination channel comprises a first channel toward the nozzle portion and is communicated with the opening, and a second channel which is communicated with the first channel and has an angle with the first channel; the illumination module comprises a lighting member; and the lighting member is positioned near a connecting point between the first channel and the second channel.

In at least one embodiment, the illumination module comprises a lighting unit and a light reflecting member; the lighting unit is positioned near one terminal of the second channel which is far away from the first channel; and the light reflecting member is positioned at the connecting point between the first channel and the second channel.

In at least one embodiment, the temperature controller is a bimetal thermostat or a thermal resistor.

In at least one embodiment, the heat storage member is consisting of heat storage material, such as magnesium oxide, iron magnesium oxide, polycrystalline silicon and silver paper.

In at least one embodiment, the heating module further comprises a cover; the cover is made of insulation and heat resistant material; and the cover covers the heating bar, the temperature controller, and the heat storage member.

Compared with the prior art, the heating bar generates heat which is stored in the heat storage member. The heat storage member heats the air and water flow in the air tube and the water tube. The temperature of the air and water is increased and the mouth of the patient is protected. Furthermore, the illumination module emits light which is projected from the opening via the illumination channel, and areas in the mouth of the patient the nozzle portion inserted in are lighted. Therefore, an extra illumination device is not need and the cost is saved.

### BRIEF DESCRIPTION OF THE DRAWINGS

FIG. 1 is an exploded view of a first embodiment of an air syringe for dentistry.

FIG. 2 is a cut away view of a second embodiment of the air syringe for dentistry of FIG. 1.

### DETAILED DESCRIPTION

Accompanying with the following drawings, the referred embodiments are provided to describe, not to limit, technical approaches in the present invention. Obviously, bearing the essence and concept of the present invention, technologists in this field can make carious changes and modifications to the present invention. It should be understood that those changes and modifications are also covered by claims of the present invention, if they are with the same purpose and within the same scope of the present invention.

It should be understood that such terms as are first, second, and etc are configured to only denote devices but not to limiting the devices. For instance, the contents hereafter may refer first to denote one device, or otherwise, refer second to denote the same device. Notice that when the phrase of “being connected to” is used hereinafter, it means either the two devices being connected or being connected to another device in between. Otherwise, when the phrase of “being directly connected to” is used hereinafter, it only means being connected without any device in between.

The terms being used hereinafter are used to describe the referred embodiment but not to limit the invention. Unless being noted in contents, the use of singular or plural nouns shall not limit the invention.

It should be understood that the use of “comprise” shall not limit the invention about describing or listing features and characteristics of the circuit. There may exists other features and characteristics of the circuit which has not been covered or listed in the invention.

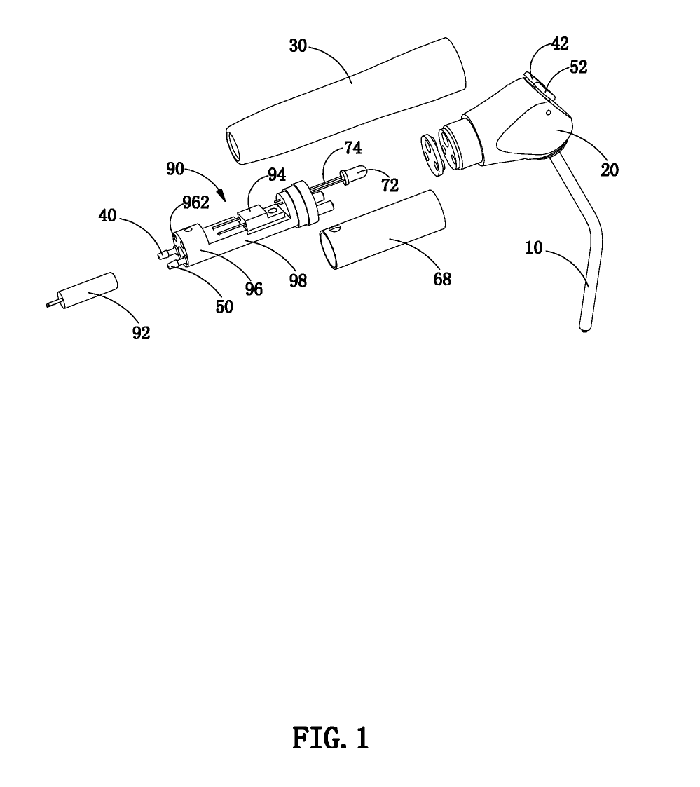

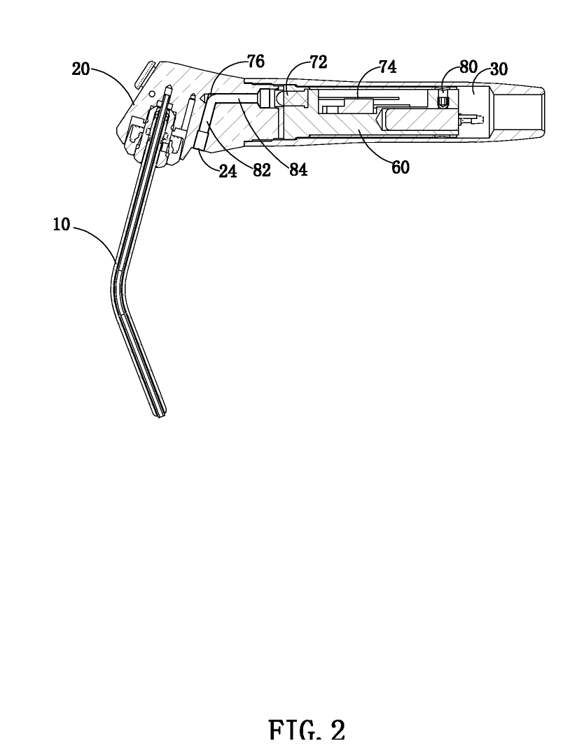

FIG. 1 and FIG. 2 illustrate an air syringe for dentistry in accordance with a first embodiment. The air syringe for dentistry includes a nozzle portion 10, a nozzle connecting member 12, a head portion 20, a head connecting member 22, a handle 30, an air tube 40, an air button 42, a water tube 50, a water button 52, a tube fixing member 60, an illumination module, and a heating module 90.

The nozzle portion 10 is connected to a first terminal of the head portion 20 via the nozzle connecting member 12 and the head connecting member 22 subsequently. In at least one embodiment, the nozzle portion 10 is permanently connected to the nozzle connecting member 12, the head connecting member 22 is permanently connected to the head portion 20, and the nozzle connecting member 12 is rotatably connected to the head connecting member 22. A second terminal of the head portion 20 is connected to the handle 30. The handle 30 covers the air tube 40, the water tube 50, and the tube fixing member 60.

The tube fixing member 60 is configured to fix the air tube 40 and the water tube 50. An upper portion of the air tube 40 and an upper portion of the water tube 50 are connected to the head portion 20. A lower portion of the air tube 40 is an air inlet which is connected to an external air supply. A lower portion of the water tube 50 is a water inlet which is connected to an external water supply.

The head portion 20 defines a tube channel inside which is configured to selectively connect the nozzle portion 10 to the air tube 40 or the water tube 50. In at least one embodiment, the air button 42 and the water button 52 are positioned at a top of the head portion 20 and are connected to the tube channel. The air button 42 is configured to control the nozzle portion 10 connect to the air tube 40. The water button 52 is configured to control the nozzle portion 10 connect to the water tube 50. The head portion 20 defines an opening 24 toward the nozzle portion 10 and an illumination channel 26 inside. The illumination channel 26 is communicated with the opening 24.

The illumination module includes a lighting unit which is positioned in the handle 30. The lighting unit is configured to emit light which is projected from the opening 24 via the illumination channel 26. The lighting unit is capable of lighting areas in the mouth of a patient the nozzle portion 10 is inserted in. In at least one embodiment, the illumination channel 26 includes a first channel 82 toward the nozzle portion 10 and is communicated with the opening 24, and a second channel 84 which is communicated with the first channel 82 and has an angle with the first channel 82.

The lighting unit includes a lighting member 72 and a power supply member 74. The lighting member 72 extends in the second channel 84. A distal end of the lighting member 72 is positioned near a connecting point between the first channel 82 and the second channel 84. The lighting member 72 is configured to emit light which is projected from the opening 24 via the first channel 82. The power supply member 74 is positioned on the tube fixing member 60 in the handle 30. In at least one embodiment, the illumination module is positioned in the first channel 82 of the head portion 20, and the lighting member 72 is a light emitting diode (LED).

In a second embodiment of an air syringe for dentistry, the lighting member 72 is positioned near one terminal of the second channel 84 which is far away from the first channel 82. The illumination module further includes a light transmitting apparatus which is positioned in the illumination channel 26. The light transmitting apparatus is configured to conduct light from a light source to the opening 24. In at least one embodiment, the light transmitting apparatus is a light reflecting member 76 which is positioned at the connecting point between the first channel 82 and the second channel 84. The light reflecting member 76 is configured to reflect light from the lighting member 72 to the second channel 84 via the first channel 82. In at least one embodiment, the light transmitting apparatus is an optical fiber which is positioned in the illumination channel 26.

The heating module 90 includes a heating bar 92, a temperature controller 94, a heat storage member 96, and a cover 98. The heating module 90 is positioned in the handle 30. The air tube 40 and the water tube 50 pass through the heat storage member 96. A plurality of holes 962 are defined in the heat storage member 96. The heating bar 92 is embedded in the plurality of holes 962. The temperature controller 94 is positioned on the heat storage member 96 and is electrically coupled to the heating bar 92. The heating bar 92 and the temperature controller 94 are electrically coupled to an external power supply or a backup power supply.

In at least one embodiment, the heating bar 92 generates heat when powered on, the temperature controller 94 is a bimetal thermostat or a thermal resistor, and the temperature controller 94 automatically cuts off the power supply of the heating bar 92 when it detects the temperature of the heat storage member 96 reaches a predetermined value.

In at least one embodiment, the heat storage member 96 is consisting of heat storage material, such as magnesium oxide, iron magnesium oxide, polycrystalline silicon and silver paper, and at least one fixing member, such as a screw 80 is positioned between the heat storage member 96 and the handle 30 to fix the tube heating module 90 inside the handle 30.

In at least one embodiment, the cover 98 is made of insulation and heat resistant material, and the cover 98 covers the heating bar 92, the temperature controller 94, and the heat storage member 96 to isolate the heating module 90 with the handle 30 for safety.

In use, the heating module 90 is powered on, the heating bar 92 generates heat which is stored in the heat storage member 96 as the heating bar 92 is embedded in the heat storage member 96. The heat storage member 96 heats the air and water flow in the air tube 40 and the water tube 50. The temperature of the air and water is increased and the mouth of the patient is protected. Furthermore, the illumination module emits light which is projected from the opening 24 via the illumination channel 26, and areas in the mouth of the patient the nozzle portion 10 inserted in are lighted. Therefore, an extra illumination device is not need and the cost is saved.

The embodiments shown and described above are only examples. Many details are often found in the art such as the other features of an air syringe for dentistry. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. An air syringe for dentistry comprising:
a nozzle portion;
a head portion connected to the nozzle portion;
a handle connected to the head portion;
an air tube and a water tube positioned in the handle; and
a heating module positioned in the handle; the heating module comprising:
a heating bar;
a temperature controller; and
a heat storage member;
wherein the head portion defines a tube channel inside which is configured to selectively connect the nozzle portion to the air tube or the water tube; the air tube and the water tube pass through the heat storage member; the heating bar is embedded in the heat storage member; and
the temperature controller is positioned on the heat storage member and is electrically coupled to the heating bar.

2. The air syringe for dentistry of claim 1, further comprising an illumination module positioned in the head portion or the handle; the head portion defines an opening toward the nozzle portion and an illumination channel inside; and the illumination channel is communicated with the opening.

3. The air syringe for dentistry of claim 1, further comprising a nozzle connecting member and a head connecting member; the nozzle portion is permanently connected to the nozzle connecting member; the head connecting member is permanently connected to the head portion; and the nozzle connecting member is rotatably connected to the head connecting member.

4. The air syringe for dentistry of claim 1, wherein the heat storage member defines a plurality of holes therein; and the heating bar is embedded in the plurality of holes.

5. The air syringe for dentistry of claim 1, further comprising an air button and a water button positioned on the head portion and are connected to the tube channel; the air button is configured to control the nozzle portion connect to the air tube; and the water button is configured to control the nozzle portion connect to the water tube.

6. The air syringe for dentistry of claim 1, wherein the temperature controller is a bimetal thermostat or a thermal resistor.

7. The air syringe for dentistry of claim 1, wherein the heat storage member is consisting of heat storage material, such as magnesium oxide, iron magnesium oxide, polycrystalline silicon and silver paper.

8. The air syringe for dentistry of claim 1, wherein the heating module further comprises a cover; the cover is made of insulation and heat resistant material; and the cover covers the heating bar, the temperature controller, and the heat storage member.

9. The air syringe for dentistry of claim 1, further comprising a tube fixing member positioned in the handle; and the tube fixing member is configured to fix the air tube and the water tube.

10. The air syringe for dentistry of claim 2, wherein at least parts of the illumination module is positioned in the illumination channel; and the illumination module is configured to emit light which is projected from the opening via the illumination channel.

11. The air syringe for dentistry of claim 2, wherein the illumination channel comprises a first channel toward the nozzle portion and is communicated with the opening, and a second channel which is communicated with the first channel and has an angle with the first channel; the illumination module comprises a lighting member; and the lighting member is positioned near a connecting point between the first channel and the second channel.

12. The air syringe for dentistry of claim 2, wherein the illumination module comprises a lighting unit and a light reflecting member; the lighting unit is positioned near one terminal of the second channel which is far away from the first channel; and the light reflecting member is positioned at the connecting point between the first channel and the second channel.
